(19) United States
(12) Patent Application Publication
(10) Pub. No.: US 2004/0027229 A1
(43) Pub. Date: Feb. 12, 2004

(54) Semiconductive ceramic, positive temperature coefficient thermistor for degaussing, degaussing circuit, and method for manufacturing semiconductive ceramic

(76) Inventors: Yasuhiro Nabika, Omihachiman-shi (JP); Mitsugu Takada, Yokaichi-shi (JP); Hiroki Tanaka, Yokaichi-shi (JP); Yoshinori Kitamura, Kouka-gun (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/182,837

(22) PCT Filed: Dec. 4, 2001
(86) PCT No.: PCT/JP01/10584

(30) Foreign Application Priority Data
Dec. 5, 2000 (JP) 2000-370477

(51) Int. Cl. H01C 7/10

(52) U.S. Cl. 338/22 R

(57) ABSTRACT

In a semiconductive ceramic which has a positive resistance temperature characteristic and is used as a degaussing thermistor element, the current attenuation characteristic is slowly changed without increasing the size of the element by setting a resistance temperature coefficient α in the range of from about 10 to 17.

### TECHNICAL FIELD

The present invention relates to positive temperature coefficient thermistors for degaussing, degaussing circuits, semiconductive ceramics used for degaussing, and methods for manufacturing semiconductive ceramics.

### BACKGROUND ART

In recent years, positive temperature coefficient thermistors have been considered for incorporated in degaussing circuits for use in CRT devices or the like. The current supplied to the degaussing circuit must be gradually decreased in order to reliably perform degaussing by a degaussing circuit. By incorporating a positive temperature coefficient thermistor which functions as a current attenuator in the degaussing circuit, it has been expected that the structure thereof can be simplified while a superior degaussing characteristic is maintained.

Positive temperature coefficient thermistors have been heretofore frequently incorporated in circuits for overcurrent protection. In particular, an overcurrent generated in a circuit is attenuated by the positive temperature coefficient thermistor, and hence, the circuit is protected from the overcurrent. In order to fulfill this purpose, the residual current must be decreased as quickly as possible by the positive temperature coefficient thermistor after the attenuation is complete. Accordingly, the positive temperature coefficient thermistors have been generally designed so that the current attenuation characteristic changes quickly.

When a positive temperature coefficient thermistor is to be incorporated in a degaussing circuit as a current attenuator, however, the current attenuation characteristic must be designed so as to change slowly. Otherwise, highly accurate degaussing cannot be performed. In consideration of the fact that the size of a thermistor body constituting a positive temperature coefficient thermistor has an influence on the current attenuation characteristic, the current attenuation characteristic has been previously designed so as to change slowly by increasing the size of the thermistor body without changing the material forming the thermistor body or the manufacturing method.

However, when a positive temperature coefficient thermistor is designed so that the characteristics thereof function optimally as a current attenuator for use in a degaussing circuit, problems may arise in that the element size is increased, in addition to an increase in material cost due to the increase in the size of the element.

### SUMMARY OF THE INVENTION

Accordingly, a primary object of the present invention is to provide a positive temperature coefficient thermistor having a current attenuation characteristic which changes slowly without increasing the size of the element.

To this end, the present invention provides a semiconductive ceramic which has a positive resistance temperature characteristic and is used for a degaussing thermistor element, wherein a resistance temperature coefficient α of the semiconductive ceramic obtained by the formula below is in the range of from about 10 to 17.

The formula is α=[ln(ρ₂/ρ₁)/(T₂−T₁)]×100 in which

ρ₁: resistivity which is 10 times the resistivity ρ₂₅ obtained when the thermistor temperature is room temperature (25° C.),

ρ₂: resistivity which is 100 times the resistivity ρ₂₅,

T₁: the temperature (° C.) at which the resistivity is ρ₁, and

T₂: the temperature (° C.) at which the resistivity is ρ₂.

The inventors of the present invention discovered that in a positive temperature coefficient thermistor having a positive resistance temperature characteristic, when the resistance temperature characteristic was slowly changed, the current attenuation characteristic was also slowly changed. As a result, the resistance temperature coefficient α is set in the range of from about 10 to 17 in the present invention.

In general, the current attenuation characteristic obtained is related to the maximum ratio Pₘₐₓ of a ratio P of the change in current. It has been said that the maximum ratio Pₘₐₓ required for a degaussing thermistor element is 0.7 or more. In view of this requirement, the resistance temperature coefficient α of a semiconductive ceramic used for a degaussing thermistor element is set to about 17 or less in the present invention in order to achieve that value of Pₘₐₓ. In addition, it has also been said that the withstand voltage required for a degaussing thermistor element is 100 V/mm. The withstand voltage is also influenced by the resistance temperature coefficient α. In order to achieve the desired withstand voltage, the resistance temperature coefficient α is set to 10 or more in the present invention.

The ratio P of the change in current can be calculated as a ratio (I₍ₙ₊₁/I₍ₙ₎) of the change between peaks (I₍ₙ₎, I₍ₙ₊₁₎) of currents adjacent to each other while it is being attenuated.

The semiconductive ceramic of the present invention preferably comprises barium titanate as a primary component, and Ba, Ti, Ca, Pb, Sr, Er, Mn and Si as accessory components.

In a degaussing circuit provided with a positive temperature coefficient thermistor formed of the semiconductive ceramic of the present invention, the residual current is increased in the degaussing circuit after degaussing since the current attenuation characteristic of the positive temperature coefficient thermistor changes slowly, and hence, the electrical power consumption may be increased in some cases. Accordingly, in order to limit the time of supplying a current to a degaussing coil in the present invention, a relay circuit is provided at the current supply path which supplies the current to the degaussing coil constituting the degaussing circuit. Accordingly, the electrical power consumption of the degaussing circuit incorporating the positive temperature coefficient thermistor which is formed of the semiconductive ceramic of the present invention can be suppressed.

In a method for manufacturing a semiconductive ceramic according to the present invention, the current attenuation characteristic can be adjusted by adjusting the cooling temperature gradient while a fired molded body of a semiconductive ceramic material is being cooled. Hereinafter, the reason for this will be described.

The electrical characteristics such as resistance temperature characteristic of a semiconductive ceramic are influenced by electrical barrier layers formed at the grain boundaries of the ceramic. In addition, the amount of the barrier layer formed in the semiconductive ceramic is proportional to the oxidized amount, and when the oxidized amount is increased, the barrier layers become larger. The oxidized amount can be adjusted by adjusting the cooling temperature gradient in the firing profile employed in a manufacturing process for the semiconductive ceramic. Accordingly, by adjusting the cooling temperature gradient in the firing profile in the present invention, the oxidized amount is changed so as to adjust the resistance temperature characteristic, and as a result, the current attenuation characteristic is controlled.

### BRIEF DESCRIPTION OF THE DRAWINGS

FIG. 1 is a side view showing the appearance of a positive temperature coefficient thermistor of the present invention.

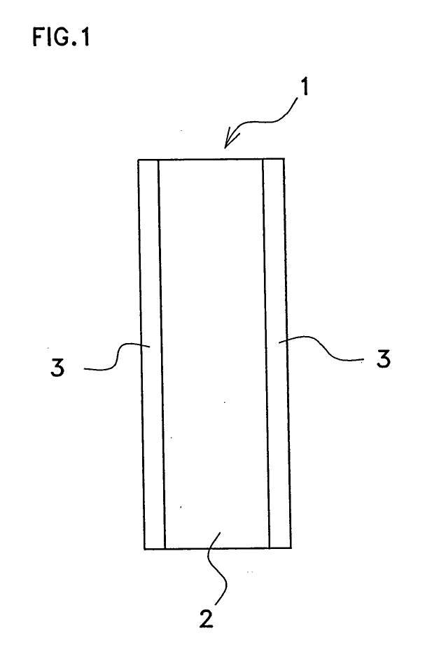

FIG. 2 is a graph showing a firing profile of a method for manufacturing a positive temperature coefficient thermistor according to one embodiment of the present invention.

FIG. 3 shows the waveform of a current being attenuated.

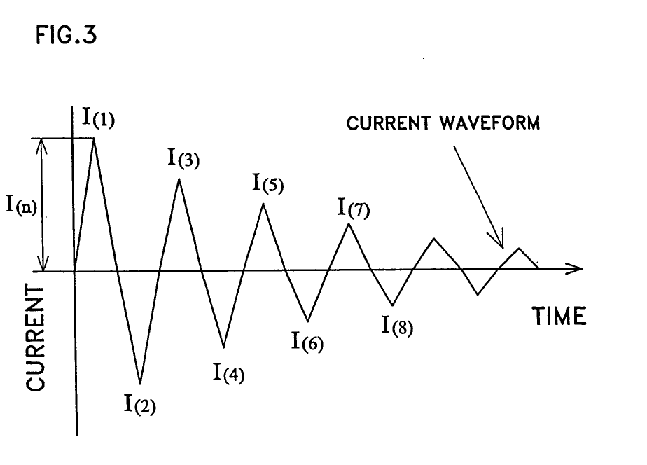

FIGS. 4A and 4B are equivalent circuit diagrams of degaussing circuits of the present invention.

### DESCRIPTION OF THE INVENTION

Hereinafter, a positive temperature coefficient thermistor of an embodiment according to the present invention will be described. This positive temperature coefficient thermistor 1 comprises a body 2 composed of a semiconductive ceramic and electrodes 3 provided on the two major surfaces of the body 2. This positive temperature coefficient thermistor 1 has a resistance temperature coefficient α in the range of from about 10 to 17 obtained by the formula (1) below.

α=[ln(ρ₂/ρ₁)/(T₂−T₁)]×100(%/° C.) (1)

in which

ρ₁: resistivity which is 10 times the resistivity ρ₂₅ obtained when the thermistor temperature is room temperature (25° C.),

P2: resistivity which is 100 times the resistivity ρ₂₅,

T₁: the thermistor temperature at which the resistivity is ρ₁, and

T₂: the thermistor temperature at which the resistivity is ρ₂.

Next, a method for manufacturing this positive temperature coefficient thermistor 1 will be described. First, after powdered BaCO₃, TiO₂, CaCO₃, PbO, SrCO₃, Er₂O₃, MnCO₃ and SiO₂ were prepared as starting materials for a semiconductive ceramic, and these starting materials were mixed together at predetermined ratios. After this mixture was wet-mixed, dehydrating and dried, calcining was performed at 1,150° C. A binder was mixed with the calcined product thus formed, so that pelletized particles were obtained.

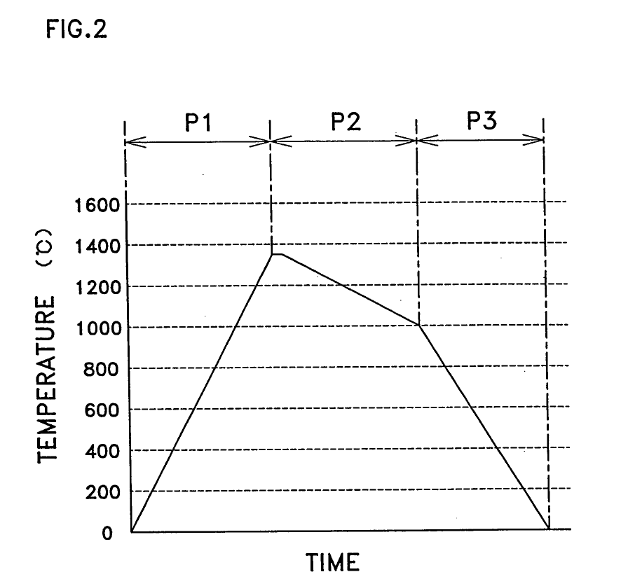

The pelletized particles thus formed were molded by applying pressure and were then fired under atmospheric conditions, thereby yielding a semiconductive ceramic. One example of a firing profile performed during this step is shown in FIG. 2. As shown, the firing profile includes a heating step P1, a first cooling step P2 and a second cooling step P3. The reason the cooling step was separately performed by the steps P2 and P3 is that there is a cooling period which influences the characteristics of the semiconductive ceramic and a cooling period which does not have any influence thereon. Accordingly, the first cooling step P2 which is a cooling period having the influence and the second cooling step P3 which is a cooling period having no influence are separately performed. The cooling profile is accurately controlled in the first cooling step P2, but in the second cooling step P3, cooling can be rapidly performed by, for example, holding the fired material under room temperature conditions.

In the firing profile described above, the cooling rate (cooling gradient) during the first cooling period P2 which influences the characteristics of semiconductive ceramic was variously changed, and various semiconductive ceramics were formed in accordance with the various firing profiles. The element size of the semiconductive ceramic thus formed was 14.0 mm in diameter and 2.5 mm thick. In addition, after the two major surfaces of the semiconductive ceramic thus formed were plated with Ni, electrodes were formed on the semiconductive ceramic by applying and baking an Ag paste, thereby obtaining a positive temperature coefficient thermistor.

For the various positive temperature coefficient thermistors thus formed, measurements of the resistivity ρ₂₅ obtained when the element temperature was set to room temperature (25° C.), the resistance temperature coefficient α, the withstand voltage property and the current attenuation characteristic (represented by the maximum ratio Pₘₐₓ of the ratio P of the change in current) were performed. The measurement results are shown in Table 1. In these measurements, the current attenuation characteristic was measured under the conditions of a voltage of 220 V, a frequency of 60 Hz, and a series resistance of 14.0 Ω. The ratio P of the change in current was obtained as the ratio P=(I₍ₙ₊₁₎/I₍ₙ₎) between the peaks (I₍ₙ₎, I₍ₙ₊₁₎) of currents adjacent to each other while the thermistor is being attenuated.

TABLE 1

| | Cooling | | | Withstand | |
|---|---|---|---|---|---|
| Sample | Rate | Resistivity | | Voltage | |
| No. | (° C./min) | (Ω · cm) | α | (V/mm) | Pₘₐₓ |
| 1 | 10.0 | 15.0 | 9.0 | 80 | 0.89 |
| 2 | 9.2 | 15.5 | 9.5 | 90 | 0.88 |
| 3 | 8.6 | 16.5 | 10.2 | 112 | 0.86 |
| 4 | 7.6 | 16.5 | 10.9 | 120 | 0.85 |
| 5 | 7.2 | 20.0 | 12.1 | 148 | 0.81 |
| 6 | 6.4 | 20.2 | 12.5 | 155 | 0.79 |
| 7 | 5.9 | 21.0 | 13.8 | 170 | 0.76 |
| 8 | 5.3 | 21.5 | 14.4 | 172 | 0.75 |
| 9 | 4.8 | 24.0 | 15.6 | 220 | 0.74 |
| 10 | 4.2 | 24.5 | 16.8 | 218 | 0.71 |
| 11 | 3.4 | 25.5 | 17.5 | 232 | 0.68 |
| 12 | 2.7 | 26.0 | 18.2 | 240 | 0.66 |

As cam be seen in Table 1, it is understood that by changing the cooling rate (cooling gradient) in the first cooling period, the current attenuation characteristic represented by the maximum ratio Pₘₐₓ of ratio P of the change in current can be accurately controlled.

It has been said that the maximum ratio Pₘₐₓ (current attenuation characteristic) required for a positive temperature coefficient thermistor used for degaussing is 0.7 or more. When the maximum ratios Pₘₐₓ (current attenuation characteristic) of the samples thus formed were studied in detail, samples 11 and 12 having a resistance temperature coefficient α of more than about 17 show that a maximum ratio Pₘₐₓ (current attenuation characteristic) of less than 0.7 (Pₘₐₓ<0.7). On the other hand, samples 1 to 10 having a resistance temperature coefficient α of about 17 or less (α≦17), show that the maximum ratio Pₘₐₓ (current attenuation characteristic) is 0.7 or more (Pₘₐₓ0.7). Accordingly, it is understood that the resistance temperature coefficient α may be set to about 17 or less (α≦17%) in order to have a maximum ratio Pₘₐₓ (current attenuation characteristic) of 0.7 or more (Pₘₐₓ0.7) which is required for the positive temperature coefficient thermistor.

In addition, it has been said that the withstand voltage required for a positive temperature coefficient thermistor used for degaussing is 100 V/mm. When the withstand voltages of samples 1 to 12 thus formed were studied in detail, samples 1 and 2 having a resistance temperature coefficient α of less than about 10 (α≦10) show that the withstand voltage is less than 100 V/mm (withstand voltage <100 V/mm). On the other hand, samples 3 to 12 having a resistance temperature coefficient α of about 10 or more (α≧10) show that the withstand voltage is 100 V/mm or more (withstand voltage ≧100 V/mm). Accordingly, it is understood that the resistance temperature coefficient α may be set to about 10 or more (α≧10) in order to have a withstand voltage of 100 V/mm or more (withstand voltage ≧100 V/mm) which is required for the positive temperature coefficient thermistor.

Accordingly, in order to realize a withstand voltage (100 V/mm or more) required for a positive temperature coefficient thermistor used for degaussing is maintained and at the same time ensure a maximum ratio Pₘₐₓ (current attenuation characteristic) of 0.7 or more which is also required for the positive temperature coefficient thermistor used for degaussing, it is understood that the resistance temperature coefficient α is in the range of from about 10 to 17 (10≦α≦17).

In order to obtain the characteristic (10≦resistance temperature coefficient α≦17) described above, it is understood that the cooling gradient (cooling rate) in the first cooling step may be controlled. In this embodiment, in particular, the cooling gradient may be controlled so that 4.2° C./minute ≦cooling rate ≦8.6° C./minute. Depending on the particular composition of the semiconductor ceramic material, other cooling gradients may be used.

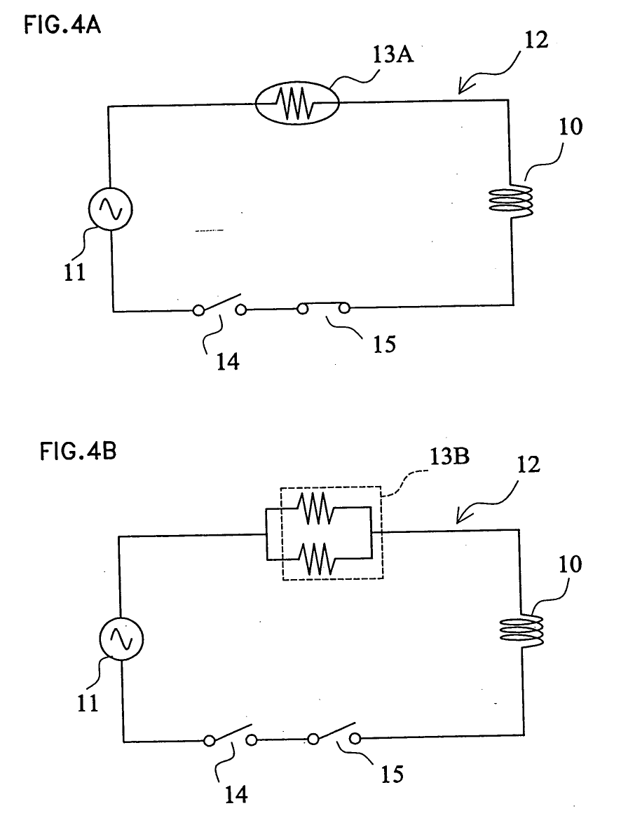

FIGS. 4A and 4B are block diagrams of degaussing circuits incorporating the positive temperature coefficient thermistor of the present invention. These degaussing circuits each have a degaussing coil 10, a DC electrical power source 11 for supplying a degaussing current to the degaussing coil 10, a positive temperature coefficient thermistor 13A or 13B provided in a current supply path 12 of the DC electrical power supply 11, and a switch 14 and a relay circuit 15 which are also provided in the current supply path 12.

As the positive temperature coefficient thermistors 13A and 13B, the positive temperature coefficient thermistor according to the present invention in which the current attenuation characteristic changes slowly is used in these degaussing circuits. Accordingly, highly accurate degaussing can be performed.

The electrical power may, however, be consumed by more than a required amount in some cases in the degaussing circuit incorporating the positive temperature coefficient thermistor having the characteristic described above, since the current attenuation characteristic of the positive temperature coefficient thermistor changes slowly. Accordingly, the electrical power consumption of the degaussing circuit shown in FIGS. 4A and 4B is suppressed by providing the relay circuit 15, which limits the time for supplying current to the degaussing coil 10, in the current supply path 12.

In FIG. 4A, a two-pin type positive temperature coefficient thermistor 13A is used which is provided with one body formed of a semiconductive ceramic. In FIG. 4B, a three-pin type positive temperature coefficient thermistor 13B is used which is provided with a pair of the above-mentioned bodies connected in parallel. As described above, the positive temperature coefficient thermistor of the present invention can be applied to both types of positive temperature coefficient thermistors. In addition, the positive temperature coefficient thermistor of the present invention can be naturally applied to a positive temperature coefficient thermistor contained in a case and to a positive temperature coefficient thermistor sealed by a resin.

### INDUSTRIAL APPLICABILITY

As has thus been described, according to the present invention, the characteristics of a positive temperature coefficient thermistor can be set so as to optimally function as a current attenuator of a degaussing circuit without increasing the material cost and the size of the thermistor.

What is claimed is:

1. A semiconductive ceramic useful for a degaussing thermistor comprising a semiconductive ceramic having a positive resistance temperature characteristic and a resistance temperature coefficient α in the range of from about 10 to 17,
wherein
α=[ln(ρ₂/ρ₁)/(T₂−T₁)]×100
in which
ρ₁: resistivity which is 10 times the resistivity ρ₂₅ obtained when the thermistor temperature is room temperature (25° C.),
ρ₂: resistivity which is 100 times the resistivity ρ₂₅,(25° C.),
T₁: the temperature at which the resistivity is ρ₁, and
T₂: the temperature at which the resistivity is ρ₂.

2. A semiconductive ceramic according to claim 1, wherein the semiconductive ceramic comprises barium titanate.

3. A semiconductive ceramic according to claim 2, wherein the semiconductive ceramic also comprises Ca, Pb, Sr, Er, Mn and Si.

4. A positive temperature coefficient thermistor which has a positive resistance temperature characteristic and is useful for degaussing, the positive temperature coefficient thermistor comprising:
a positive temperature coefficient thermistor body composed of a semiconductive ceramic according to one of claims 1 to 3; and
a pair of electrodes at spaced apart points of the positive temperature coefficient thermistor body.

5. A degaussing circuit comprising:
a degaussing coil;
an electrical power source for supplying a current to the degaussing coil;
a current supply path which supplies current to the degaussing coil from the electrical power source; and
a positive temperature coefficient thermistor provided in the current supply path;
wherein the positive temperature coefficient thermistor is a positive temperature coefficient thermistor according to claim 4.

6. A degaussing circuit according to claim 5, including a relay circuit in the current supply path adapted to limit the time of supplying the current to the degassing coil.

7. A method for manufacturing a semiconductive ceramic for use in a degaussing positive temperature coefficient thermistor comprising:
firing a molded body of a semiconductive ceramic material; and
cooling the fired molded body;
wherein the cooling temperature gradient is controlled during the cooling period which influences the characteristics of the semiconductive ceramic such that the resistance temperature coefficient α in the range of from about 10 to 17,
wherein
α=[ln(ρ₂/ρ₁)/(T₂−T₁)]×100
in which
ρ₁: resistivity which is 10 times the resistivity ρ₂₅ obtained when the thermistor temperature is room temperature (25° C.),
ρ₂: resistivity which is 100 times the resistivity ρ₂₅ (25° C.),
T₁: the temperature at which the resistivity is ρ₁, and
T₂: the temperature at which the resistivity is ρ₂,
whereby current attenuation characteristic of the semiconductive ceramic is adjusted.

8. A method for manufacturing a semiconductive ceramic according to claim 7, wherein the fired semiconductive ceramic material is a barium titanate.

9. A method for manufacturing a semiconductive ceramic according to claim 8, wherein the fired semiconductive ceramic material comprises Ca, Pb, Sr, Er, Mn and Si.

10. A method for manufacturing a semiconductive ceramic according to one of claims 7 to 9, wherein the cooling gradient is in the range of about 4.2 to 8.5° C./minute.
